(19) United States
(12) Patent Application Publication
(10) Pub. No.: US 2012/0020196 A1
(43) Pub. Date: Jan. 26, 2012

(54) NETWORK-BASED REAL-TIME OPTIC DISC WRITER DEVICE

(75) Inventors: Mao Huai WENG, Taipei Hsien (TW); Wen Chu CHUANG, Taipei Hsien (CN)

(73) Assignee: ACARD Technology Corp., Taipei Hsien (TW)

(21) Appl. No.: 12/963,766

(22) Filed: Dec. 9, 2010

(30) Foreign Application Priority Data
Jul. 26, 2010 (TW) 099214218

(51) Int. Cl. G11B 7/12

(52) U.S. Cl. 369/47.49; G9B/7.097

(57) ABSTRACT

A network-based real-time optic disc writer device has at least two disc writer assemblies and a monitoring unit. Each of the disc writer assemblies has a disc writer unit and host controller with a detection unit. The disc writer unit is electrically connected to the host controller and has a robotic arm, at least two disc writers, and an optic disc deposition zone. The at least two disc writers and the optic disc deposition zone are arranged at one side of the robotic arm to allow the robotic arm to selectively pick up and deposit optic discs and also to allow the at least two disc writers to perform continuous writing to optic discs. The monitoring unit communicates with the host controller of each of the disc writer assemblies, so as to enable ready communication through networks, real-time notification and monitoring and continuous, un-interrupted writing operation of optic discs.

### BACKGROUND OF THE INVENTION

1. Field of the Invention

The present invention is related to a network-based real-time optic disc writing/burning device, and more particular to an arrangement of combination of at least two writer device and a monitoring unit, which enables excellent performance of real-time notification and monitoring, ready communication through network, and un-interrupted continuous disc writing, and which is applicable to diverse types of network-based real-time optic disc writing/burning device or the likes.

2. Description of Related Art

A known optic disc writing/burning device is often composed of a host controller and a plurality of disc writers. The plurality of disc writers is operated in such a way that a source disc into which data are to be written and at least one blank destination disc are manually deposited into corresponding disc writers first for carrying out disc writing operation. Due to that manual operation of disc writing/burning is time consuming, automatic continuous disc writing devices are available. These devices are effective in carrying out continuous automatic disc writing, yet such devices are generally incapable of pausing or stopping the disc writing operation even though an abnormal situation of the disc writing devices occurs, such as incomplete burning of an optic disc, incorrect disc pick-up operation by a robotic arm of the writing device. Thus, when it comes to the attention of a user, it is often tool late to save the loss. In case that the abnormal situation of the disc writing device is caused by malfunction of the robotic arm, if such an abnormal situation is not discovered early, then it may not be of sufficient to correct the problem before writing-completed discs are shipped to the purchasers, or a lot of discs are destroyed by the malfunction. Apparently, these known devices do not meet the needs of general users.

### SUMMARY OF THE INVENTION

Accordingly, the primary objective of the present invention is to provide a network-based real-time optic disc writer device that features a combination of at least two disc writer assemblies and a monitoring unit, wherein communication and control between the monitoring unit and a host controller of each of the disc writer assemblies are realized through wired transmission or wireless transmission, the host controller of each of the disc writer assemblies is allowed to control actuation/de-actuation and operation mode of the optic disc writer device of the present invention and record starting time and ending time of data writing operation and other related information through inputting, the host controller comprises a detection unit for real-time detection of operation status of a disc writer unit of the disc writer assembly, the disc writer unit is in electrical connection with the host controller, and at least two disc writers and an optic disc deposition zone are arranged at one side of a robotic arm to allow the robotic arm to selectively pick up and deposit optic discs and also to allow the at least two disc writers to perform continuous writing to optic discs, so that real-time notification and monitoring, ready control connection through network communication, and un-interrupted continuous data writing to discs can be enabled thereby significantly improving the overall operation functionality and efficiency of the present invention.

In order to achieve the foregoing objective, the present invention provides a network-based real-time optic disc writer device, comprising at least two disc writer assemblies and a monitoring unit. Each of the disc writer assemblies comprises a host controller and a disc writer unit. The host controller comprises a detection unit. The disc writer unit is electrically connected to the host controller and comprises a robotic arm, at least two disc writers, and an optic disc deposition zone. The at least two disc writers and the optic disc deposition zone are arranged at one side of the robotic arm to allow the robotic arm to selectively pick up and deposit optic discs and also to allow the at least two disc writers to perform continuous writing to optic discs. The monitoring unit communicates with the host controller of each of the disc writer assemblies for control purposes, so as to enable real-time monitoring and continuous writing operation of optic discs. As such, the present invention is advantageous in real-time notification and monitoring, ready communication through networks, realization of continuous, un-interrupted writing operation, to thereby enhance overall functionality of the present invention and reduce unnecessary waste of material in disc writing/burning operation.

### BRIEF DESCRIPTION OF THE DRAWINGS

The present invention can be fully understood from the following detailed description of a preferred embodiment with reference to the accompanying drawings, in which:

FIG. 1 is a perspective view showing an embodiment according to the present invention;

FIG. 2 is a top plan view illustrating an operation of a disc writer unit of the embodiment according to the present invention;

FIG. 3 is a top plan view illustrating an operation of a printer unit of the embodiment according to the present invention;

FIG. 4 is a side elevational view illustrating the operation of the disc writer unit of the embodiment according to the present invention; and

FIG. 5 is a front view of the embodiment according to the present invention.

### DETAILED DESCRIPTION OF THE PREFERRED EMBODIMENTS

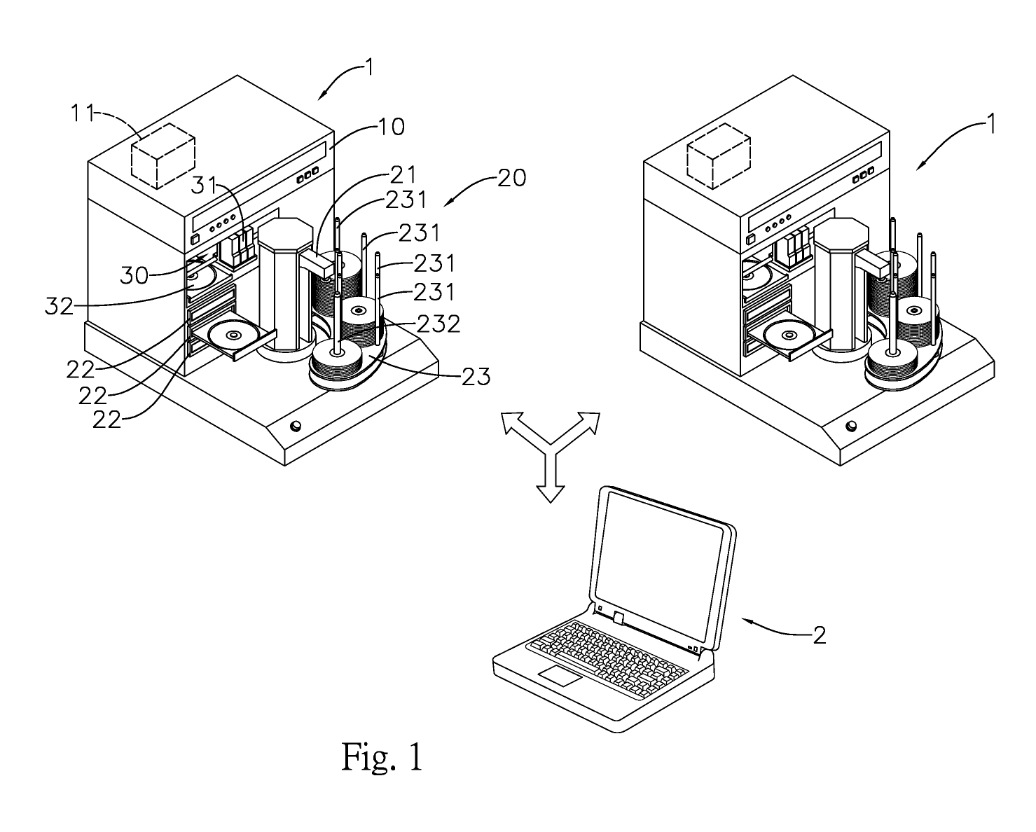

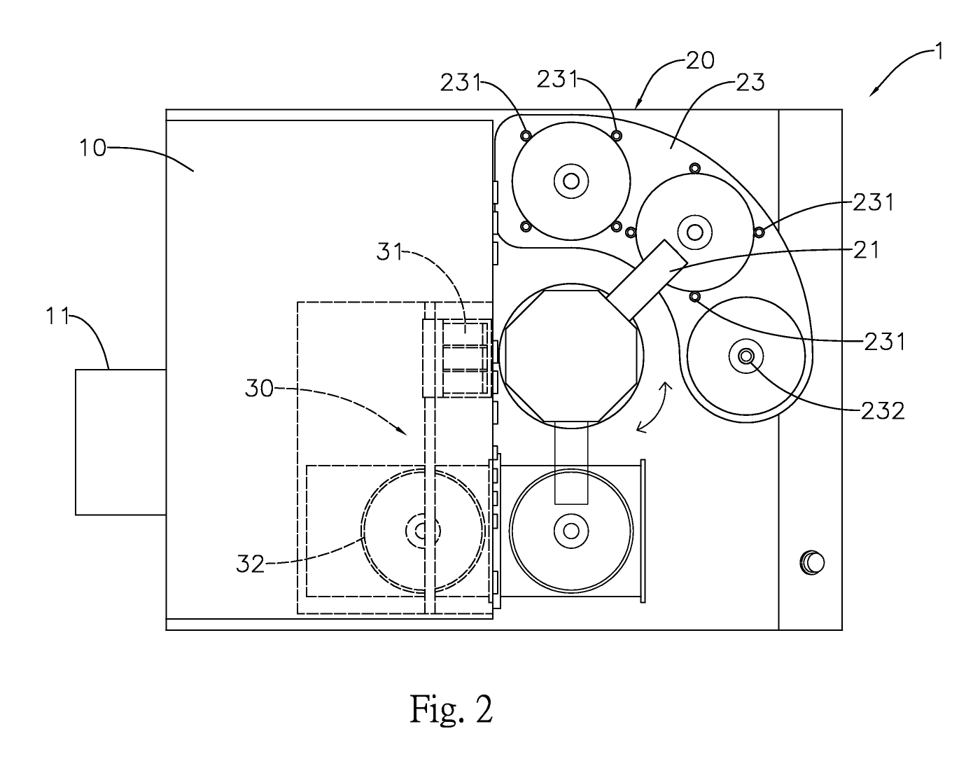

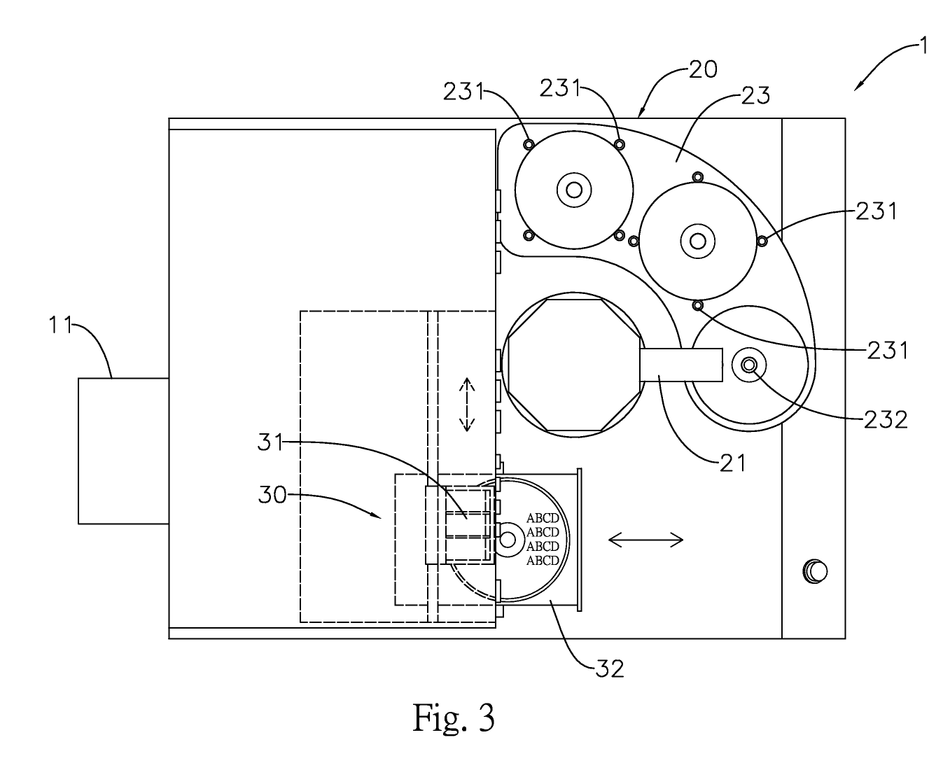

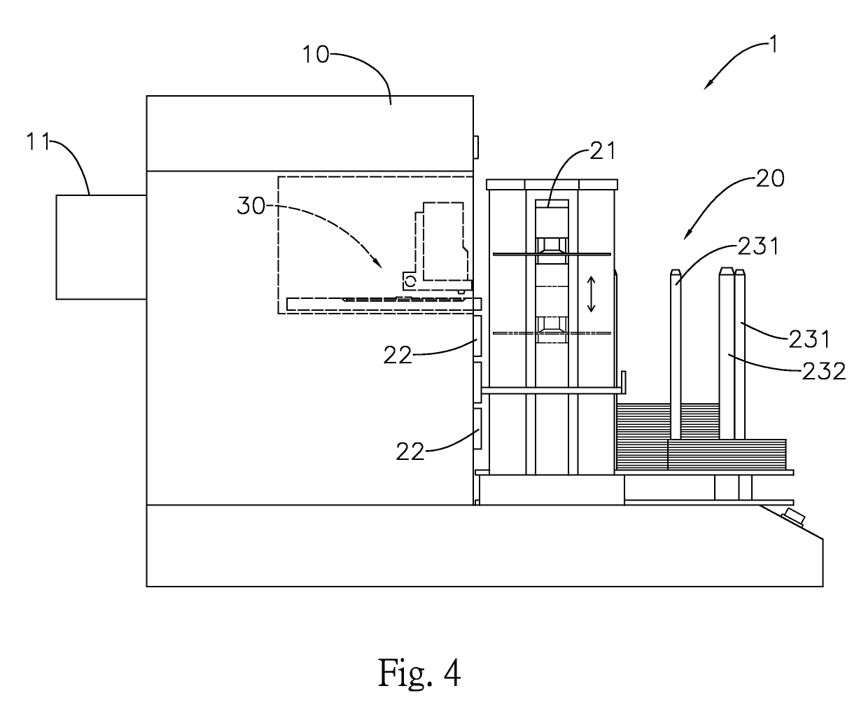

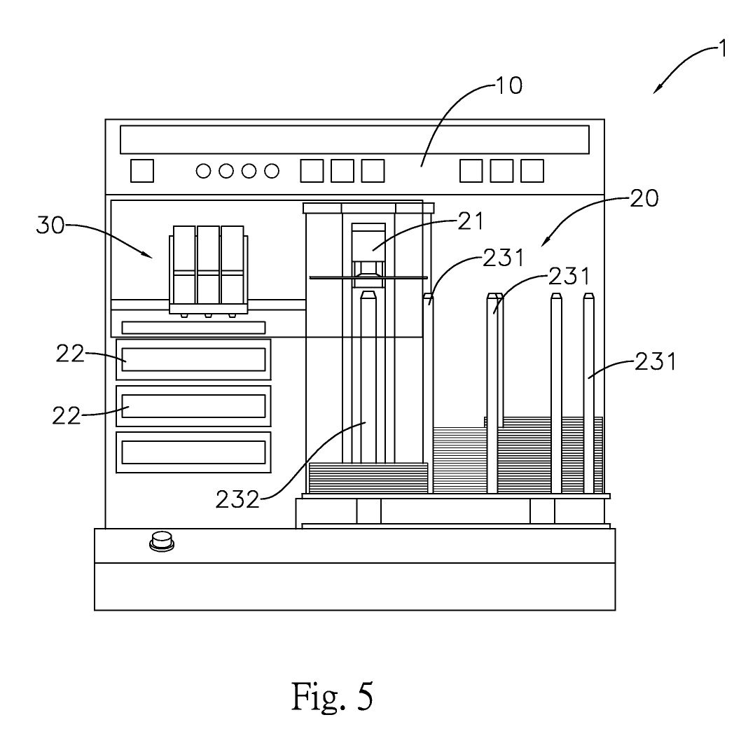

With reference to the drawings and in particular to FIGS. 1-5, the present invention provides a network-based real-time optic disc writer device. The network-based real-time optic disc writer device of the present invention is constructed by comprising the following constituent components/devices that will be descried as follows.

At least two disc writer assemblies 1 are provided, and each of the disc writer assemblies 1 comprises a host controller 10 and a disc writer unit 20. The host controller 10 controls actuation/de-actuation and operation mode of the optic disc writer device according to the present invention and records starting time and ending of disc writing as well as other related information through inputting. Further, the host controller 10 comprises a detection unit 11, which detects operation status of the disc writer unit 20. The disc writer unit 20 is electrically connected to the host controller 10 and the disc writer unit 20 comprises a robotic arm 21, at least two disc writers 22, and an optic disc deposition zone 23. The at least two disc writers 22 and the optic disc deposition zone 23 are arranged at one side of the robotic arm 21 to allow the robotic arm 21 to selectively pick up and deposit optic discs and also to allow the at least two disc writers 22 to perform continuous writing to optic discs.

Also provided is a monitoring unit 2, which communicates with the host controller 10 of each of the disc writer assemblies 1 for control purposes, so as to enable real-time monitoring and continuous normal writing of optic discs. The communication and control performed between the monitoring unit 2 and the host controller 10 of each of the disc writer assemblies 1 is done with either wired transmission or wireless transmission. The monitoring unit 2 can be for example a computer, a mobile phone, or a personal digital assistant (PDA).

Each of the disc writer assemblies 1 is further provided with a printer assembly 30, which is arranged beside the robotic arm 21. The printer assembly 30 is electrically connected to the host controller 10 and the printer assembly 30 comprises a printer 31 and a disc tray 32. The tray 32 is controlled by the host controller 10 to extend/withdraw and is for receiving an optic disc of which a writing operation has been completed. The printer 31 is operated to form printing of information or patterns on the writing-completed disc. The optic disc deposition zone 23 is provided with a to-be-written site defined by a plurality of retention stalks 231 at one end portion thereof and a completed-disc deposition site defined by at least one positioning stalk 232 at an opposite end portion thereof.

The above described arrangement forms a network-based real-time optic disc writer device according to the present invention. As shown in FIGS. 1-5, the features of the present invention are that a combination of at least two disc writer assemblies 1 and a monitoring unit 2 is provided, wherein communication and control between the monitoring unit 2 and a host controller 10 of each of the disc writer assemblies 1 are realized through wired transmission or wireless transmission, the host controller 10 of each of the disc writer assemblies 1 is allowed to control actuation/de-actuation and operation mode of the optic disc writer device of the present invention and record starting time and ending time of data writing operation and other related information through inputting, the host controller 10 comprises a detection unit 11 for real-time detection of operation status of a disc writer unit 20 of the disc writer assembly 1, the disc writer unit 20 is in electrical connection with the host controller 10, and at least two disc writers 22 and an optic disc deposition zone 23 are arranged at one side of a robotic arm 21 to allow the robotic arm 21 to selectively pick up and deposit optic discs and also to allow the at least two disc writers 22 to perform continuous writing to optic discs, so that real-time notification and monitoring, ready communication through networks, and un-interrupted continuous data writing to discs can be enabled and prevention of the disc writer assembly 1 from continuously performing data writing operation in case of abnormal situation, such as incomplete burning of optic disc, incorrect disc pick-operation by the robotic arm 21, and malfunctioning of the robotic arm 21. With the printer assembly 30 comprising a disc tray 32 that is extendible/withdrawable through control by the host controller 10 for accommodating a writing-completed optic disc therein, a printer 31 of the printer assembly 30 is allowed to print patterns or information on the wringing-completed disc accommodated in the disc tray 32, whereby an integrated network-based real-time optic disc writer device that features both data writing and printing is provided. In a practical operation of the present invention, when malfunction of the disc writer assemblies 1 or a special situation occurs, the host controller 10 of each of the disc writer assemblies 1 notifies the monitoring unit 2 (which can be for example a computer, a mobile phone, or a PDA) through wired transmission or wireless transmission so that the monitoring unit 2 receives the notification through wired transmission or wireless transmission (such as transmission of an e-mail, a short message, a voice message, or a control signal) in a real time manner to allow for performance of manual trouble shooting, or direct performance of resetting of the disc writer assemblies 1 to immediately resume a normal writing operation. Further, to prevent the occurrence of interruption of writing operation due to the above described situation, the monitoring unit 2 may notify, through the wired transmission or wireless transmission, another one of the disc writer assemblies 1 to carry out continuous writing operation, whereby the present invention is advantageous in real-time notification and monitoring, ready control connection through network communication, actuation of continuous, un-interrupted writing operation, and integrated process for data writing and printing. Thus, overall practicability and functionality can be improved.

What is claimed is:

1. A network-based real-time optic disc writer device, comprising:
at least two disc writer assemblies, each of which comprises a host controller and a disc writer unit, the host controller comprising a detection unit, the disc writer unit being electrically connected to the host controller and comprising a robotic arm, at least two disc writers, and an optic disc deposition zone, the at least two disc writers and the optic disc deposition zone being arranged at one side of the robotic arm to allow the robotic arm to selectively pick up and deposit optic discs and also to allow the at least two disc writers to perform continuous writing to optic discs; and
a monitoring unit, which communicates with the host controller of each of the disc writer assemblies for control purposes, so as to enable real-time monitoring and continuous writing operation of optic discs.

2. The network-based real-time optic disc writer device according to claim 1, wherein communication and control performed between the monitoring unit and the host controller of each of the disc writer assemblies is realized through wired transmission or wireless transmission.

3. The network-based real-time optic disc writer device according to claim 1, wherein the monitoring unit comprises one of a computer, a mobile phone, and a personal digital assistant.

4. The network-based real-time optic disc writer device according to claim 1, wherein each of the disc writer assemblies comprises a printer assembly, which is arranged beside the robotic arm, the printer assembly being electrically connected to the host controller and comprising a printer and a disc tray, the tray being is controlled by the host controller to selectively extend/withdraw for receiving an optic disc of which a writing operation has been completed, the printer being operable to form printing of information on the writing-completed dis.

5. The network-based real-time optic disc writer device according to claim 1, wherein the optic disc deposition zone comprises a to-be-written site defined by a plurality of retention stalks at one end portion thereof and a completed-disc deposition site defined by one positioning stalk at an opposite end portion thereof.
